(19) United States
(12) Patent Application Publication
(10) Pub. No.: US 2025/0317675 A1
(43) Pub. Date: Oct. 9, 2025

(54) Rotating Audio Generating Apparatus and Methods

(71) Applicant: Vahe Haroutunian, Carlsbad, CA (US)

(72) Inventor: Vahe Haroutunian, Carlsbad, CA (US)

(21) Appl. No.: 19/049,989

(22) Filed: Feb. 10, 2025

Related U.S. Application Data
(60) Provisional application No. 63/551,190, filed on Feb. 8, 2024.

(51) Int. Cl. H04R 1/02

(52) U.S. Cl. CPC H04R 1/026; H04R 2201/025

(57) ABSTRACT

The present invention disclosed is a system that improves the layout and sound delivery of speaker systems. The system is made up of one or more speakers that are mounted onto a rotatable bracket and brace that allows for the speaker to rotate about the x and y axes. This design allows users to tailor their speaker setup to meet the needs of the room where the system will be installed so to minimize overlap between the sounds produced by each speaker and to drastically reduce the dead zone areas. The result is that the listeners in the room will perceive sound that is much higher in quality then conventional systems that are currently available.

### RELATED APPLICATIONS

This application claims priority to U.S. Provisional Patent Application Ser. No. 63/551,190, for “Rotating Audio Generating Apparatus and Methods,” filed Feb. 8, 2024, and currently co-pending, the entirety of which is fully incorporated herein by reference.

### FIELD OF THE INVENTION

The present invention relates generally to an apparatus and method for rendering an audio sound field within a three-dimensional space that incorporates the use of rotatable speakers that also have the ability to vary the sound produced.

### BACKGROUND OF THE INVENTION

The design of speaker systems is often a complex process because of how critical it is to ensure each individual speaker is placed correctly. If the system is designed without the location of the listener(s) in mind then a high-quality audio system will not perform to its full capability. The drop in quality is attributable to the poor speaker placement because the sound produced by the sound system is unable to effectively and efficiently reach the listener(s). To ensure that sound systems are designed properly, larger venues typically hire audio engineers to ensure a proper layout is achieved. Additionally, there are different sound systems that are available to the consumer that try to ensure proper delivery of sound.

In places such as high-end concert halls or theaters, the design of the walls in conjunction with the speaker layout plays a pivotal role in the overall design of these spaces. Specifically, the walls are designed so that the soundwaves reflect off of them and travel throughout the entire space to ensure that each listener present can clearly hear the audio no matter where they are situated. This level of design often requires precise engineering design that is not practical or economically feasible for a majority of people.

So, to compensate, individuals have to turn to alternate solutions to achieve a similar sound quality. There are two different systems that have emerged to try and remedy the problem. The first is with surround sound systems, and the other is with spatial audio.

Surround sound systems use multiple speakers, each with multiple audio channels, to deliver sound to listeners. As the name suggests, the speakers are placed at predetermined points throughout a room so that the listener is able to perceive all of the different sounds that surround them. These systems are commonly used in movie theaters, but have become more prevalent in in-home theater setups. Additionally, these systems use directional speakers, each of which have their own copy of the sound to be delivered. If surround systems are setup incorrectly, then the sound produced by each individual speaker in the system can interfere with each other, or not reach the listener at all; both of which result in a drop in sound quality.

Spatial audio systems work to place different sounds in different locations within a space or targeted area to create a three-dimensional sound effect. The goal of these systems is to create an immersive viewing and/or listening experience with a speaker system. Spatial audio systems were designed to address the issues of surround sound because they rely on effective sound mixing to tailor the timing and positioning of each individual sound produced. The drawback to spatial audio systems is that they only target effective sound delivery to a specific three-dimensional area. Once a listener leaves the targeted area, then they will notice a significant drop in sound.

Accurate localization or sourcing of sound is still a key goal for any sound system, despite the availability of any of the above-mentioned systems. Critically, these systems often still have dead zones where no sound reaches the listener, or there is a noticeable variation in the sound quality that is delivered depending on where a speaker is located in relation to the position of a listener.

This problem is compounded for a majority of locations that would like to have high quality sound, but lack the resources to employ a full-time audio engineer to design an ideal system. Consequently, there is a need in the art for a system that streamlines the process of speaker placement.

### SUMMARY OF THE INVENTION

Generally, the present invention is able to produce a sound field in a three-dimensional space through the use of rotatable speakers that have variable sound control. Each system has a predetermined number of speaker housing units that is dependent on the size and overall layout of the space where the system will be installed. Further, each individual speaker housing unit holds a number of different speakers that each produce their own sound depending on the number of different dynamic drivers that are installed.

The placement of each speaker housing unit, and each individual speaker within the unit, is done to ensure that there is minimal to no overlap between the speakers and maximal coverage of the room is achieved. This creates a more uniform and crisp sound that is heard throughout the entire space and eliminating any dead areas that are frequently common in the industry. The aim of every system that is installed is to try and place as many listener(s) within the center image of two speakers. When done correctly, the result is a much more immersive audio experience in every space that the present invention is installed in.

In one embodiment of the present invention, there are multiple speakers mounted onto a vertical strut some distance apart from each other. Each individual speaker is installed within their own housing unit and subsequently mounted onto its own bracket and base. The bracket and base work in unison with each other such that the movements of a PTZ camera are mimicked. This means that each housing unit is able to fully rotate about both the x and y axes at any given time. This feature provides a tremendous amount of flexibility in how it can be used and where it can be installed.

In another embodiment of the invention the system is mounted onto a wall strut in place of a vertical strut and operates in a similar manner to the embodiment described above. The big distinction here is that this alternative embodiment is also able to rotate about the z-axis. This is achieved because the base that each speaker is mounted onto is radially attached to the wall mount through a rotating rod. Effectively, this alternative embodiment creates a three-dimensional audio field that is able to be continually adjusted.

Generally, the process covers a number of different steps that depend on whether the positioning of each speaker is fixed or can be constantly changed as individuals move within a space. Regardless, the first step is always to determine the size and overall layout of the room to determine how many individual speaker units are needed for the room. Next, the use type of the room needs to be determined so that the listener location can be ascertained. A room being used as a dining area for a restaurant is going to have very different needs then a room that is used as a general viewing area for a conference room. The final step will be to position each individual speaker unit based on both the room layout and room use.

The positioning of each speaker can either be static or dynamic, which is entirely dependent on the system that is installed. When the entire system is static, then positioning of each individual speaker is fixed and largely will remain the same until the needs of the space are changed (such as altering the overall layout). When the entire system is dynamic each speaker will be able to track the movement of the listeners and be able to move as the individual moves. The advantage of a dynamic system is that there will be almost no dead area within a room and the sound quality in one area will be almost identical to another area.

The entire system will be controlled by a modified DMX controller that is setup to control the movement of the speaker housing units. These controllers are typically used to control lighting, but here the DMX controller is setup to control the audio output and the movement of the speakers instead. The DMX controller can be setup to control each speaker through a direct wired or wireless connection, and is either preprogrammed or controlled by an operator in real time.

These and other objects, features, and advantages of the present disclosure will become apparent upon reading the following detailed description of exemplary embodiments of the present disclosure, when taken in conjunction with the appended drawings, and provided paragraphs.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an individual apparatus of the present invention;

FIGS. 2A and 2B are perspective views of an alternative embodiment of the present invention that is installed on a rotating tilt and pan speaker system;

FIGS. 3A and 3B are perspective views of an alternative embodiment of the present invention that is installed onto a vertical mounting system;

FIGS. 4A and 4B are perspective views of the different prospective layouts of the system, and the corresponding soundwaves, installed in a restaurant;

FIG. 5 show different movement patterns that the individual speakers of the present invention can be programmed to follow;

FIG. 6 is a schematic overview of the control system for the present invention that controls speaker movement;

FIG. 7 is a schematic overview of the control system for the present invention that fully controls speaker movement and volume output; and

FIG. 8 is a flow chart showing the order of operations to program the speaker movement for the present invention.

### DETAILED DESCRIPTION

The subject rotating loudspeaker apparatus and method (collectively referenced herein as “System”) may be used for a wide variety of audio purposes, including indoor and outdoor use.

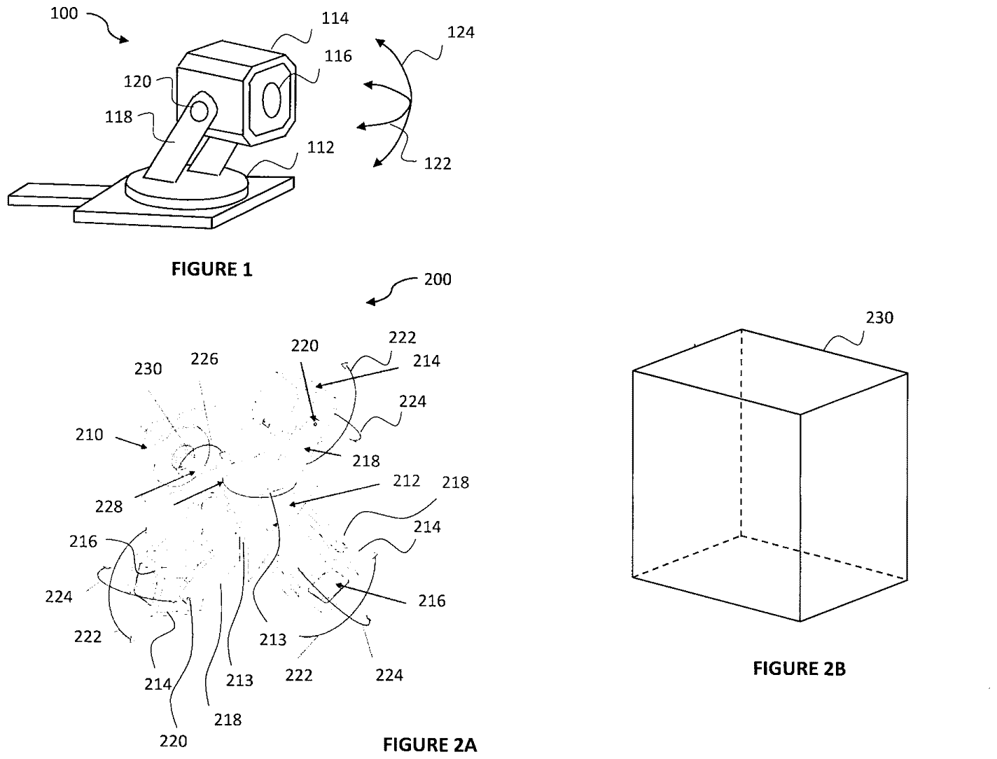

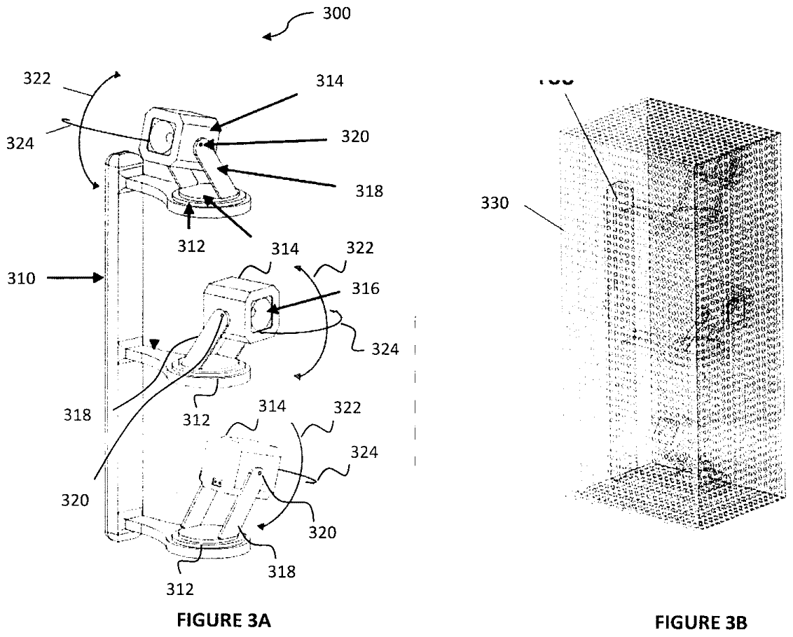

Referring to FIG. 1, a single unit of the rotatable speaker assembly that makes up part of the present invention is shown and generally designated as apparatus 100. Apparatus 100 is made up of a multitude of different components that allow apparatus 100 to deliver sound at a number of different angles. This is primarily achieved through base 112 and bracket 118. Base 112 not only connects the entire unit to whatever strut is used, such as a wall strut (see FIG. 2A) or a vertical strut (see FIG. 3A), but it is also able to rotate about the y-axis along direction 122 because it will be powered either by a direct drive motor or a belt driven motor. Bracket 118 is mounted onto base 112 and allows speaker housing 114 to rotate about the x-axis by following direction 124 due to attachment point 120.

Bracket 118 operates mechanically similar to a PTZ camera. This means that the speaker housing unit 114 located in bracket 118 is able to move about both the x and y axes due to a belt driver motor, or a direct drive motor located within the interior of bracket 118. The use of this system for bracket 118 provides a high degree of accuracy in speaker placement and also provides for a wide variety of different placement options. Additionally, the movement of bracket 118 can either be controlled through a direct wired connection, or it can be controlled wirelessly through a Bluetooth or WiFi connection.

Speaker 116 is located within speaker housing 114 and can be made up by a number of different dynamic drivers. The choice of driver is entirely dependent on the use case for apparatus 100. Further, speaker 116 can only have one dynamic driver installed, or it can have multiple. In a nonlimiting example, speaker 116 has three different dynamic drivers (woofer, mid-range, and tweeter) so that it can play a full spectrum of sounds and while still being an excellent choice for a wide variety of different scenarios.

The disclosure for speaker 116 is merely illustrative and not intended as a limiting disclosure. In reality the design of speaker 116 is extremely flexible. It can be installed to only have a single dynamic driver, or have anywhere from two, three, four, or up to thirty two dynamic drivers. Each dynamic driver can either be a tweeter, midrange, woofer, sub-woofer, which provides rotating audio apparatus a great deal of flexibility in the different settings. In a nonlimiting example, the dynamic drivers needed to accurately project the sound of a human voice in a conference room is very different then the dynamic drivers that will be needed to provide sound delivery in the dining area of a restaurant.

Additionally, each speaker 116 can be controlled either through a wired connection, a wireless connection, or some combination of both. Power to each speaker 116 can be delivered by a power supply that is wired directly to each unit, employ the use of a power cable to plug into a wall, use battery power, or use some combination of the three. Other components common to speakers and audio components may be incorporated to enhance functionality, including passive or active crossovers; a single (for each unit), or multiple amplifiers; synthesizers; electronic components that identifying special configurations and animate/inanimate objects.

There are a number of different methods and accompanying devices that can be used to control the entire operation of rotating audio generating apparatus 100. These devices include the use of motors, actuators, gearing and sensors for detecting orientation (including accelerometers). Additionally, in alternative embodiments rotating audio generating apparatus 100 can also have multiple functions aside from sound delivery. These different functions can include video recording and lighting control when alternative embodiments have lights installed onto speaker housing unit 114.

In operation, apparatus 100 will be installed and designed to meet the needs of the environment where the unit will be installed. Another consideration will be to determine whether the rotation of each speaker 116 should be independent of other speakers 116 installed onto the unit, or whether all of the speakers should act in unison with each other.

Referring now to FIG. 2A, an alternative embodiment of the present invention fully assembled and installed onto a fully rotating tilt and pan speaker system. The general designation of the embodiment shown is system 200 and is shown in FIG. 2A without speaker cover 230 installed. The benefit of system 200 is that it allows each individual speaker to be rotated about all three axes. System 200 employs the use of three different speaker housings 214 mounted onto rotatable base 213 that are in turn mounted onto hub 212. In this embodiment hub 212 was sized for three different rotatable bases 213, but this disclosure was not intended to be limited. Instead, it was shown purely for illustrative purposes as it is important to note that it is fully envisioned that hub 212 can be sized to incorporate a lower or higher number of speakers. Each speaker housing 214 consists of at least one speaker 216, and is configurable to support multiple different dynamic drivers depending on the use case. It is also fully envisioned that other components, such as lighting, can also be installed onto speaker housing 214.

Each speaker housing 214 is rotatably attached to the base 212 through the use of bracket 218. Bracket 218 connects to the sides of speaker housing 214 at attachment point 220, which acts is the pivot point for speaker housing 214 as it rotates about the x-axis as it travels along direction 222. Rotatable base 213 itself is rotatable about the y-axis along direction 224. The ability of each unit to travel along directions 222 and 224 allows each unit to be pointed at a high number of different directions to provide the broadest audio coverage possible.

Wall mount 210 is radially connected to hub 212 by rotating rod 228 at attachment point 230. Wall mount 210 can be installed on almost any surface, which in turn allows system 200 to be installed on any given surface as well. Rotating rod 228 allows for the entire system to rotate about z-axis by following direction 226; providing even more positional flexibility. Rotating rod 228 can either be solid and installed in a straight line, or it can be installed so that it comes off the wall at a predetermined angle to position system 200 at a more ideal angle. Further, rotating rod 228 can move at a variable speed.

Whenever system 200 is rotated in one direction, such as along x-axis, system 200 can be locked out of moving along either direction 224 or direction 226. Other embodiments of system 200 fully contemplate the speakers being able to move about all three axes simultaneously with each other.

Referring now to FIG. 2B, system 200 is shown with speaker cover 230 installed to cover the entire unit. Speaker cover 230 is designed to fit over the entirety of system 200 and is constructed out of any widely available speaker fabric that is known in the art. Speaker fabric is the material used because the fabric itself is designed and manufactured with soundwaves in mind. Specifically, the speaker fabric does not significantly impede or disrupt the travel of soundwaves that are generated by speaker 216.

Referring now to FIG. 3A, an alternative embodiment of present invention is shown. This system is generally designated as system 300, and system 300 restricts movement to only about the x and y axes.

Vertical strut 310 serves as the attachment point for each base 312 and is shown here with only three units installed. However, this was not intended to be a limiting disclosure and it is fully envisioned that in other embodiments, vertical strut 310 can be sized to accommodate more or less bases 312 depending on the needs of any given application. Vertical strut 310 can be permanently attached to any given surface either through screws or any other method known in the art.

Each speaker housing 314 is mounted to base 312 by bracket 318 and has their own 316 located in the interior. The placement of each base 312 was intentionally done so to minimize sound interference between each speaker 316. Speaker housing 314 is able to move about the x-axis along direction 322 due in part to attachment point 320, and is able to rotate about the y-axis along direction 324 due to bracket 318.

System 300 is particularly suited for the longitudinal manipulation of sound because each speaker 318 can move independently of one another. In some uses, a design goal of system 300 may be to mimic the sounds of a moving object while the listener is static. Each speaker 318 will be independently controlled, meaning that its rotation and sound volume will vary, so that the desired effect is achieved. This will create a much more immersive experience for the listener as system 300 is fine tuned for the given application. Additionally, system 300 can also be setup to mimic the sounds produced by a moving object.

Referring now to FIG. 3B, system 300 is shown with speaker cover 330 covering the entire system. Speaker cover 330 is designed to fit over the entirety of system 300 and is constructed out of any widely available speaker fabric that is known in the art. Speaker fabric is the material used because the fabric itself is designed and manufactured with soundwaves in mind. Specifically, the speaker fabric does not significantly impede or disrupt the travel of soundwaves that are generated by speaker 316.

Both systems 200 and 300 may employ the use of one or more reflective plates to even better tailor the sound delivery. The reflective plate may be comprised of plastic, metal, fiberglass, wood, or any other material known in the art that has superior sound reflective properties. Additionally, the plate can be customized to take the form of any shape a user may need.

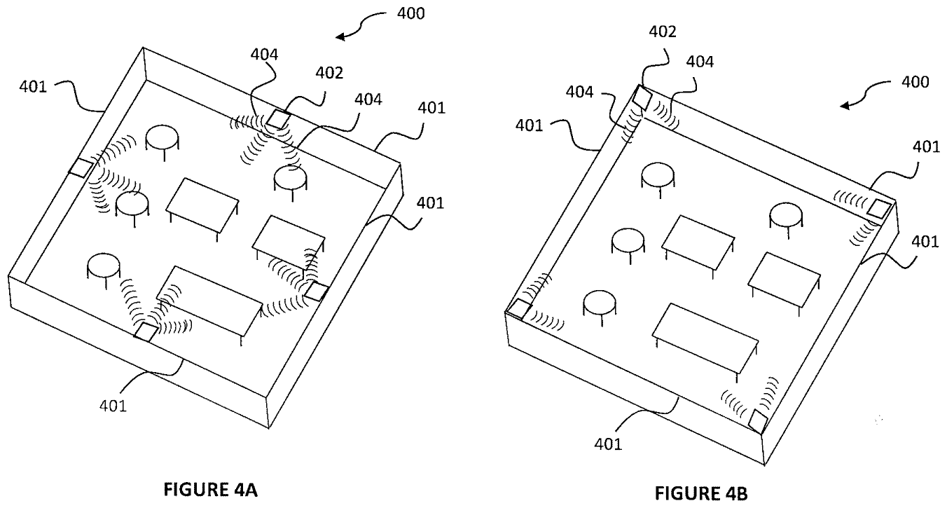

FIGS. 4A and 4B show rotating audio generating apparatus 100 installed in a restaurant but in two different layouts. These different layouts are generally designated as system 400 and are made up of units 402 and soundwaves 404. FIG. 4A shows four different individual units 400 mounted onto the halfway point of wall 401. FIG. 4B also shows four different individual units 400 mounted onto walls 401, but instead, each unit 400 is installed in the corner of walls 401. The versatility of units 402 allow for both configurations to deliver the same sound quality and have little to no impact on the sound quality delivered.

Further, each unit 402 can either be system 200 or system 300 depending on the specific needs of a room, but each unit 402 in both Figures was intentionally placed to minimize the risk of any dead space. The individual speakers that make up unit 402 are positioned so that the overlap between individual soundwaves 404 are minimized. The minimization occurs because each speaker in unit 402 can not only be angled away from each other, but they can also be angled such that complete audial coverage of the entire room is achieved. The goal of this layout is to try and have as many end listeners positioned withing the center of focus of at least two different speakers. This goal ensures that the best sound quality is delivered to as many different individual listeners as possible.

The different systems shown in FIGS. 4A and 4B are not intended to be limiting because the entire system is adaptable for use in a wide variety of different settings. This includes a majority of, if not all, indoor structures that have at least three different walls for the system to be mounted onto. Additionally, these systems can be installed outdoor to deliver sound to a targeted three-dimensional area so that sound interference from ambient sources are minimized, if not all together eliminated.

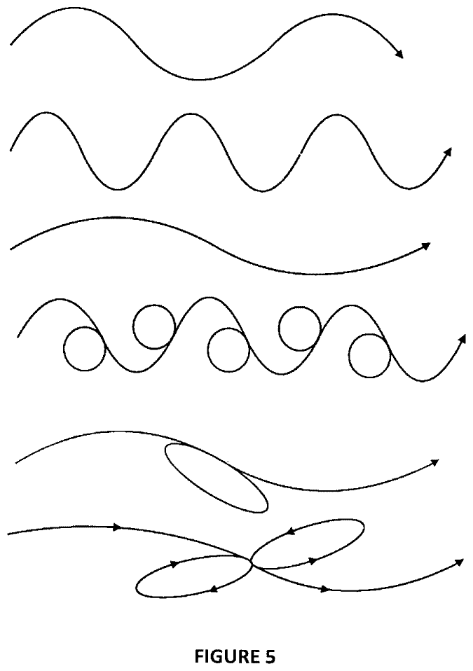

Referring now to FIG. 5, a number of different travel paths that each individual speaker 116 that are a part of apparatus 100 can take. These different paths demonstrate the wide range of movement that each speaker 116 is capable of. The final pattern that speaker 116 will follow is dependent on the audio to be played, and the location that apparatus 100 will be installed at.

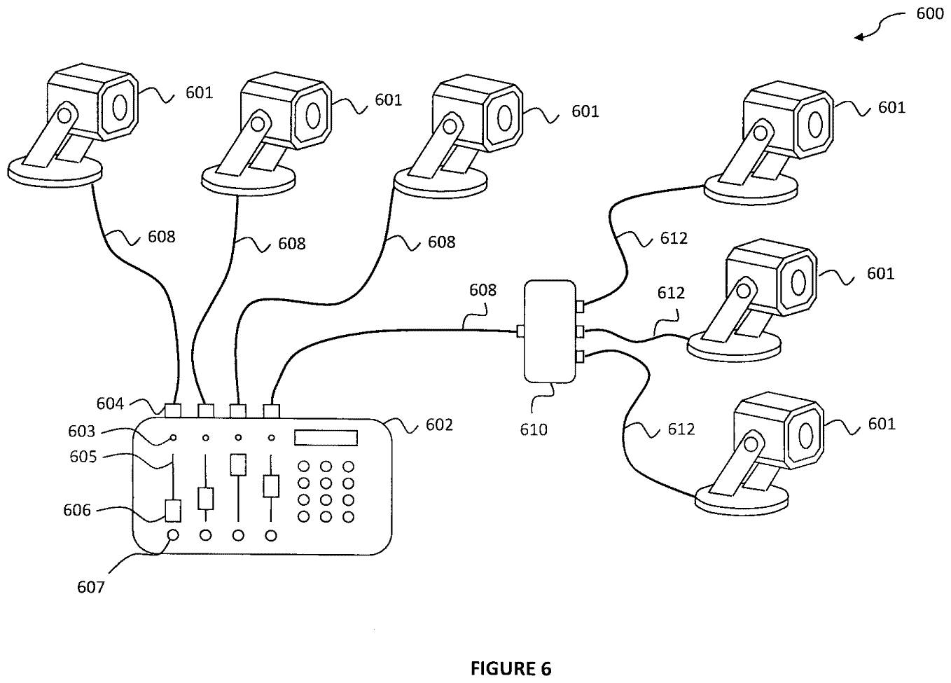

Referring now to FIG. 6, an illustrative schematic of a control system that controls the movement of each individual apparatus 601 is shown and generally designated as system 600.

One half of the entirety of system 600 is controlled by DMX controller 602 in order to fine tune the movement of each individual apparatus 601. Apparatus 601 as shown and discussed here, has a similar makeup and operation as apparatus 100 that was shown when discussing FIG. 1 in detail. DMX controller 602 provides a great deal of flexibility for the overall system. The controller can either be preprogrammed by a user to execute a certain set of movements, or a user can use DMX controller 602 in real time to control each speaker 601 during a live event. Further, the speed of movement that is prompted by the DMX controller can be variable, but it is not so fast or so slow to result in audio distortion.

Each individual apparatus 601 is controlled by DMX controller 602 through cable 608 by being plugged into the corresponding channel 604. Cable 608 itself is a DMX cable, but any other material known in the art, such as XLR, is fully contemplated herein. Additionally, while only one cable 608 is shown between apparatus 601 and channel 604, it may be advantageous to provide more than one cable to apparatus 601 to fine tune the control of each unit. For example, to provide greater control over the pan and tilt of each apparatus 601, then a first cable 608 and a first channel 604 is responsible for the pan movement, while a second cable 608 and a second channel 604 is responsible for the tilt movement.

To change the movement of each individual apparatus 601, then a user simply moves tab 606 along track 605 in the corresponding direction until the desired movement is achieved. Once apparatus 601 is moving in the desired direction, then the movement can be registered into controller 602 by pressing scenes button 603. To alternate between adjusting the pan and tilt, then the user just needs to press button 607.

DMX splitter 610 can be used when the movement of apparatus 601 is synchronized over different units. This is advantageous to use when the desired movement path is intended to be the same between the individual apparatus 601 in a single system. When this situation occurs, then each apparatus 601 has its own DMX splitter cable 612 that runs from splitter 610 to each apparatus 601 that is connected to splitter 610.

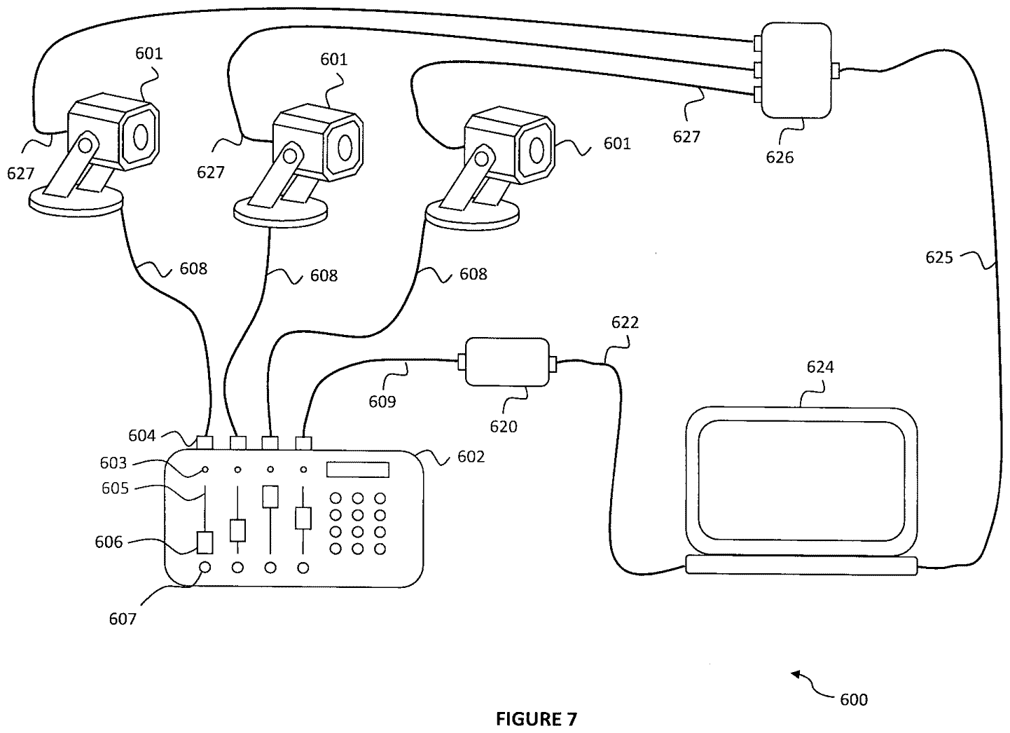

Referring now to FIG. 7, the control system discussed in detail for FIG. 6 is shown to provide an overview of the synchronization process between speaker movement and audio output. Control of the audio output will largely be done through computer 624, but any other device that can achieve a similar result, such as a tablet or smartphone, is fully envisioned as an equivalent substitute for computer 624.

The first step is to upload the audio file that is going to be played onto computer 624, and to also load the same audio file into a program that is capable of sequencing the audio output to the registered DMX control settings. The key component to making this connection work is DMX adapter 620. DMX adapter 620 connects DMX controller 602 to computer 624 through DMX converter cable 622, and DMX cable 609 to DMX controller 602. DMX adapter 620 in most scenarios will be a DMX to USB converter, but any other signal converter that is currently known and used in the art is fully contemplated herein. DMX adapter 620 lets a user program the movements of apparatus 601 through DMX controller 602, and have the synchronizer match the programmed movements to the desired audio output. Computer 624 will send the audio output signal through cable 625 to each apparatus 601 through the use of audio splitter 626. Each apparatus 601 gets its own individual audio connection through audio splitter cable 627.

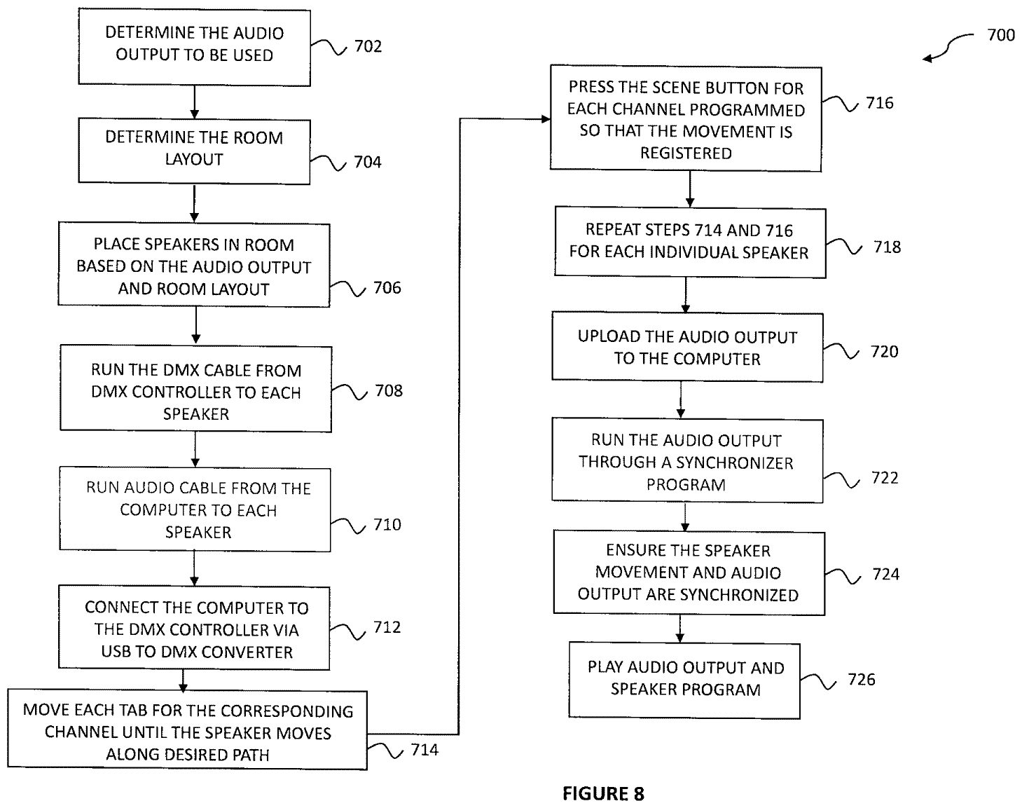

FIG. 8 shows the order of operations for the present invention and is generally designated as system 700. These steps are shown sequentially in the FIG. 8 to provide an illustration of how the system will operate; however, these steps can be carried out either sequentially, or in any other order that will achieve a similar result.

The first few steps of the process shown here cover the basic installation procedures. Specifically, step 702 requires an installer to determine the audio output to be used. This is critical because the audio output, along with the room layout selection of step 704, will determine the speaker movement path. If the audio output is not determined then a resulting drop in sound quality may occur due to a dead space occurring, or some other kind of audio distortion. Determining the room layout at step 704 is also crucial because it is important to understand where a majority of listeners will be located to ensure that proper audio coverage is achieved. Next, the speakers can finally be located around the room at step 706. With the speakers located around the room, each speaker can have the required number of DMX cables run from the controller to each individual speaker at step 708, and have the audio cable run from the computer controlling the audio output to each speaker at step 710.

The next series of steps provide an overview on how the programming of the entire system 700 will occur. At step 712, the computer needs to be connected to the DMX controller via a USB to DMX converter. Next, steps 714 and 716 require an installer to program the movement of each individual speaker by moving the corresponding tab for each channel that is connected to a speaker, and then immediately pressing the scene button on the DMX controller to register the movement path. The process of step 714 and 716 is repeated for each individual speaker that is apart of system 700 at step 718. The final programming steps require an installer to upload the audio output to the computer at step 720, and run the audio output through the synchronizer program so that the computer can match the audio output to the programmed speaker path.

Finally, at step 724 the installer can troubleshoot the entirety of system 700 at step 724 to ensure that the speaker movement and audio output are synchronized. If they are not, then additional tweaks to the system will need to be made by either adjusting the registered speaker movement at the DMX controller, or tailoring the sound delivery on the computer. Once, the troubleshooting process is completed, then the installer has completed the entire job and can play the audio output and speaker program at step 726.

Various features of preferred embodiments of the present invention have been discussed in connection with certain embodiments for the sake of clarity and ease of understanding. Further embodiments incorporating the possible combinations of features described above in connection with specific embodiments are fully contemplated herein.

While there have been shown what are presently considered to be preferred embodiments of the present invention, it will be apparent to those skilled in the art that various changes and modifications can be made herein without departing from the scope and spirit of the invention.

What is claimed is:

1. A rotatable speaker assembly comprising:
a speaker housing unit that as an exterior and interior;
at least one dynamic driver located within the interior of the speaker housing unit;
a bracket that is attached to the exterior of the speaker housing unit and is mounted onto a base;
wherein the bracket allows the speaker housing unit to rotate about the x-axis, and
wherein the base allows the speaker housing unit to rotate about the y-axis.

2. The rotatable speaker assembly of claim 1, wherein the at least one dynamic driver further comprises at least one tweeter dynamic driver, at least one mid-range dynamic driver, and at least one woofer dynamic driver.

3. The rotatable speaker assembly of claim 2, wherein the bracket rotates the speaker housing unit either through the use of a belt drive motor or a direct drive motor.

4. The rotatable speaker assembly of claim 2, wherein the base rotates the speaker housing unit either through the use of a belt drive motor or a direct drive motor.

5. A vertical speaker mounting system comprising:
a vertical strut mounted onto a planar surface;
a first rotatable speaker assembly mounted onto the vertical strut;
a second rotatable speaker assembly mounted onto the vertical strut some distance above the first rotatable speaker assembly,
wherein the first rotatable speaker assembly and second speaker assembly further comprises:
a speaker housing unit that as an exterior and interior;
at least one dynamic driver located within the interior of the speaker housing unit;
a bracket that is attached to the exterior of the speaker housing unit and is capable of rotation about the x-axis; and
a base for the speaker housing unit to mount onto and is capable of rotation about the y-axis.

6. The rotatable speaker assembly of claim 5, wherein the at least one dynamic driver further comprises at least one tweeter dynamic driver, at least one mid-range dynamic driver, and at least one woofer dynamic driver.

7. The rotatable speaker assembly of claim 6, wherein the bracket rotates the speaker housing unit either through the use of a belt drive motor or direct drive motor.

8. The rotatable speaker assembly of claim 6, wherein the base rotates the speaker housing unit either through the use of a belt drive motor or direct drive motor.

9. A rotatable wall mounted speaker system comprising:
a wall mount secured to a planar surface;
a rotatable rod that extends out from the wall mount and attaches to a base that is located some horizontal distance away from the wall mount;
at least one speaker assembly that is mounted onto the base,
wherein the at least one speaker assembly further comprises,
a speaker housing unit that as an exterior and interior;
at least one dynamic driver located within the interior of the speaker housing unit;
a rotatable bracket that is attached to the exterior of the speaker housing unit and is mounted onto a rotatable base;

10. The rotatable speaker assembly of claim 9, wherein the rotatable bracket rotates about the x-axis.

11. The rotatable speaker assembly of claim 10, wherein the rotatable base rotates about the y-axis.

12. The rotatable speaker assembly of claim 11, wherein the at least one dynamic driver further comprises at least one tweeter dynamic driver, at least one mid-range dynamic driver, and at least one woofer dynamic driver.

13. The rotatable speaker assembly of claim 11, wherein the bracket rotates the speaker housing unit either through the use of a belt drive motor or a direct drive motor.

14. The rotatable speaker assembly of claim 11, wherein the base rotates the speaker housing unit either through the use of a belt drive motor or a direct drive motor.

15. The rotatable speaker assembly of claim 11, wherein the rotatable rod rotates the base either through the use of a belt drive motor or a direct drive motor.
